(19) United States
(12) Patent Application Publication
(10) Pub. No.: US 2010/0084930 A1
(43) Pub. Date: Apr. 8, 2010

(54) SPINDLE MOTOR

(76) Inventor: Yong Joo Kim, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/574,425

(22) Filed: Oct. 6, 2009

(30) Foreign Application Priority Data
Oct. 7, 2008 (KR) 10-2008-0098068

(51) Int. Cl. H02K 5/24

(52) U.S. Cl. 310/51

(57) ABSTRACT

A spindle motor is disclosed that is capable of mitigating vibration caused by eccentricity of a disk and a turn table due to optimization of a cross-sectional area occupied by balls relative to that of a space in which the balls are stored.

### CROSS-REFERENCE TO RELATED APPLICATION

This application claims the benefit under 35 U.S.C. §119 of Korean Application No. 10-2008-0098068, filed Oct. 7, 2008, which is hereby incorporated by reference in its entirety.

### BACKGROUND

The present disclosure relates to a spindle motor. A spindle motor performs the function of rotating a disk to enable an optical pickup which linearly reciprocates in an optical disk drive (ODD) to read data recorded on the disk.

A spindle motor is stored with a bearing for decreasing vibration caused by eccentricity of a disk and eccentricity of a turn table mounted on the disk, and a conventional example of spindle motor will be described with reference to FIGS. 1 and 2.

Referring to FIG. 1, a bearing 10 is stored in a storage space 22 formed on a turn table 20, moves to an opposite direction of eccentricity by centrifugal force during rotation of the turn table 20, and offsets vibration generated by the eccentricity of the disk and the turn table 20 to reduce the vibration.

The conventional spindle motor is stored with approximately twelve balls 10, and a cross-section occupied by the balls 10 relative to a cross-section of the storage space 22 formed at the turn table is about 50%.

Generally, eccentricity of at least 0.25 g·cm exists on a disk. Vibration created when a disk having eccentricity of 0.15˜0.25 g·cm is mounted on the turn table 20 and a spindle motor is driven was 1.7˜2.2 G as shown in FIG. 2.

Therefore, the conventional spindle motor is disadvantageous in that a relatively large vibration is generated due to non-realization of optimization relative to a cross-section occupied by the balls 10 relative to a cross-section of the storage space 22 of the turn table 20.

### BRIEF SUMMARY

Thus, the present disclosure intends to solve the aforementioned conventional drawback and to provide a spindle motor capable of decreasing vibration.

A spindle motor according to one aspect of the present disclosure comprises: a turn table simultaneously rotating with a rotation shaft and having a ring-shaped race portion at one side of the turn table, wherein the disk is mounted on the other side of the turn table; a cover coupled to one side of the turn table to seal the race portion; and a plurality of balls stored in the space formed by the race portion and the cover, wherein a circumferential alignment length of the balls measured along a central point of the balls is 16˜35% of a circumferential length of the race portion while the balls are mutually contacted within the race portion.

A spindle motor according to another aspect of the present disclosure comprises: a turn table simultaneously rotating with a rotation shaft and having a ring-shaped race portion at one side of the turn table, wherein the disk is mounted on the other side of the turn table; a rotor having a rotor yoke sealing the race portion by being fixed at the rotation shaft; a stator installed about the rotation shaft for rotating the rotation shaft; and a plurality of balls stored in the space formed by the race portion and the cover, wherein a circumferential alignment length of the balls measured along a central point of the balls is 16˜35% of a circumferential length of the race portion while the balls are mutually contacted within the race portion.

### BRIEF DESCRIPTION OF THE DRAWINGS

FIG. 1 is a plan cross-sectional view of a turn table according to a conventional spindle motor.

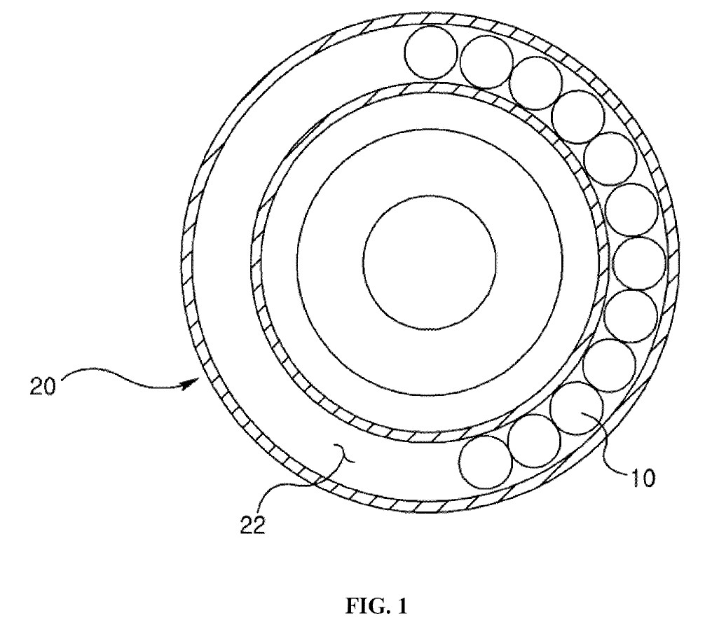

FIG. 2 is a graph illustrating an amount of vibration according to a conventional spindle motor.

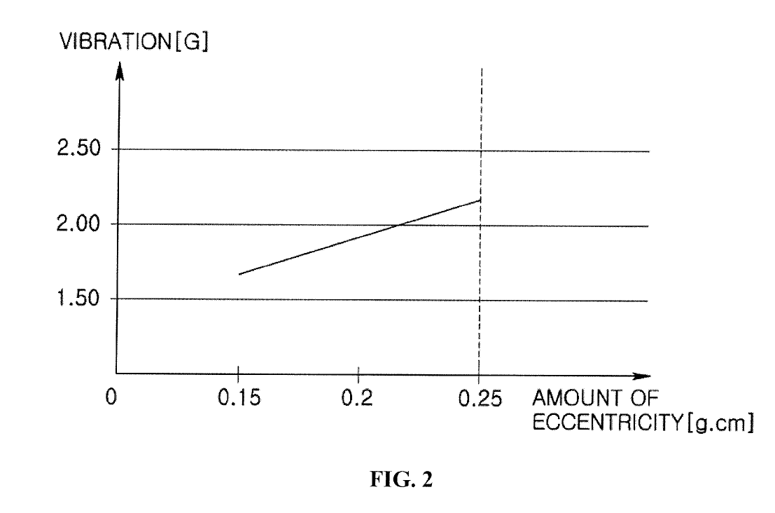

FIG. 3 is a cross-sectional view illustrating a spindle motor according to an exemplary implementation of the present disclosure.

FIG. 4 is a cross-sectional view along line “A-A” of FIG. 3.

FIG. 5 is a graph illustrating an amount of vibration of a spindle motor according to an exemplary implementation of the present disclosure.

### DETAILED DESCRIPTION

A spindle motor according to the exemplary implementations of the present disclosure will be described in detail with reference to the accompanying drawings.

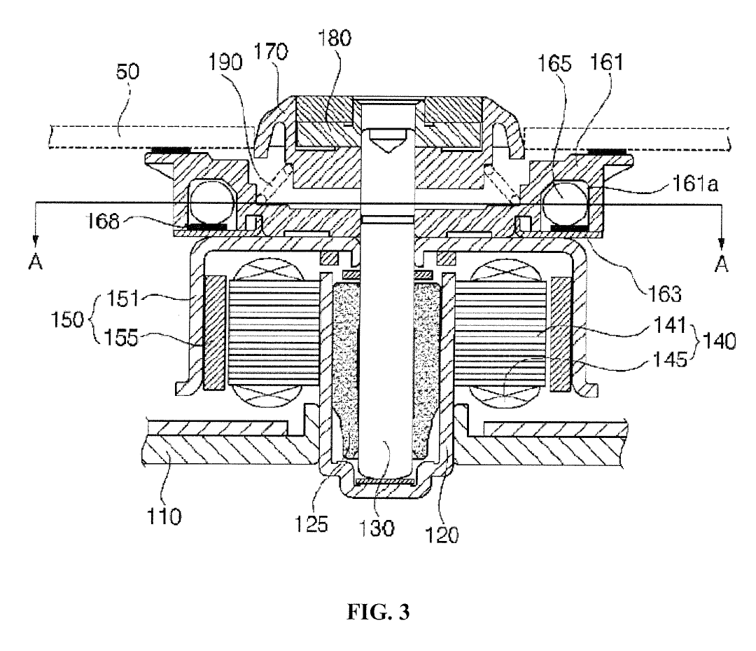

FIG. 3 is a cross-sectional view illustrating a spindle motor according to an exemplary implementation of the present disclosure.

Referring to FIG. 3, a bearing housing 120 is vertically erected on a base 110.

Hereinafter, in the description of directions and surfaces of constituent elements including the base 110, a surface and a direction facing a vertical upper side of the base 110 are referred to as ‘upper surface and upper side’ and a surface and a direction facing a lower side of the base 110 are referred to as ‘lower surface and lower side’.

The bearing housing 120, cylindrically provided with an upper surface being opened, is fixed at the base 110 at a lower side peripheral surface. A bearing 125 is press-fitted and fixed in an inner peripheral surface of the bearing housing 120. The bearing 125 is supported by a lower side of a rotation shaft 130 and rotatably installed therein.

The bearing housing 120 is fixed by a stator 140 and the rotation shaft 130 is fixed by a rotor 150. The stator 140 has a core 141 coupled to the outer periphery of the bearing housing 120, and a coil 145 wound on the core 141. The rotor 150 includes a rotor yoke 151 supported on the rotation shaft 130 exposed to the outside of the bearing housing 120, and a magnet 155 coupled to the rotor yoke 151 in opposition to the stator 140.

Accordingly, when a current is applied to the coil 145, the magnet 155 is rotated by the interaction between the coil 145 and the magnet 155 to rotate the rotor yoke 151 and the rotation shaft 130.

An outer periphery of the rotation shaft 130 on the rotor yoke 155 is fixed by a turn table 161 which is simultaneously rotated with the rotation shaft 130, and turn table 161 is supportably mounted thereon with a disk 50. The outer periphery of the rotation shaft 130 on the turn table 161 is vertically movably mounted along the rotation shaft 130 with a center guide member 170 that supports the disk mounted on the turn table 161, and the outer periphery of the rotation shaft 130 on the center guide member 170 is fixed by a bush 180. The center guide member 170 is prevented from disengaging upward the rotation shaft 130.

Between the turn table 161 and the center guide member 170 there is formed a resilient member 190 that supports the center guide member 170 in the axial and radial directions of the rotation shaft 130.

If the turn table 161 is rotated along with the rotation shaft 130, vibration is generated by eccentricity of the disk 50 and the turn table 161. A space formed inside the turn table 161 for reducing the vibration caused by the eccentricity is stored with a plurality of balls 165.

To be more specific, the turn table 161 has a ring-shaped race portion 161a that forms a travel path of the ball 165, and is formed thereunder with a cover 163 that seals the race portion 16a. The plurality of balls 165 is stored in an air-tightly sealed space formed by the cover 163 and the race portion 161a.

The ball 165 is moved in the opposite direction of eccentricity by centrifugal force when the turn table is rotated to mitigate the vibration by offsetting the vibration generated by the eccentricity of the disk 50 and the turn table 161. A felt 168 for preventing the ball 165 from slipping is formed on an upper surface of the cover 163.

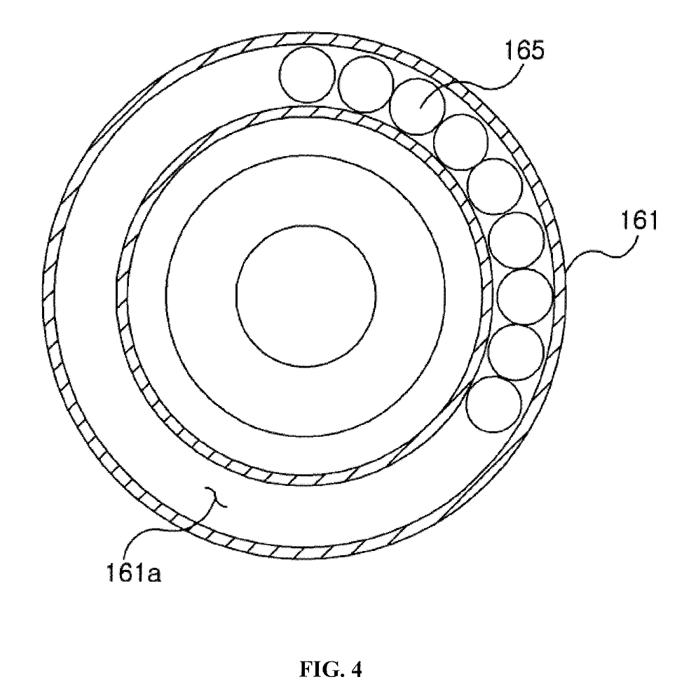

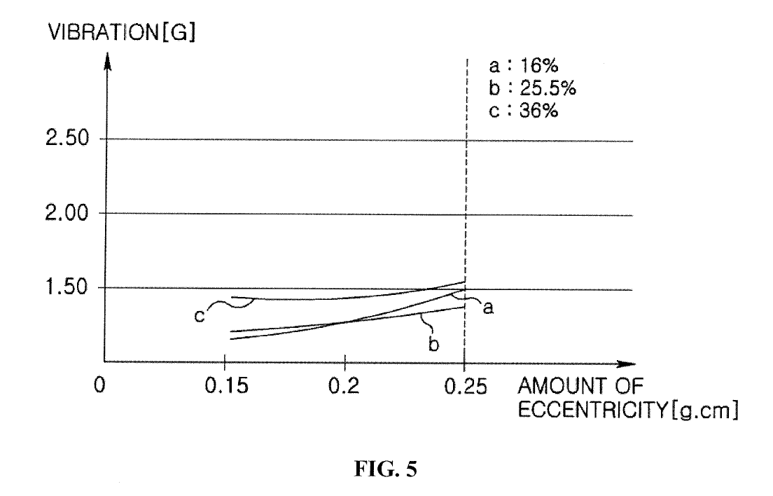

The spindle motor according to the present disclosure optimizes each cross-sectional area ratio of the ball 165 relative to that of race portion 161a in order to minimize the vibration, explanation of which will be described reference to FIGS. 4 and 5.

FIG. 4 is a cross-sectional view along line “A-A” of FIG. 3, and FIG. 5 is a graph illustrating an amount of vibration of a spindle motor according to an exemplary implementation of the present disclosure.

Referring to FIG. 4, the number of balls, approximately 5 to 9, is stored in the air-tightly sealed space formed by the race portion 161a and the cover 163, where a circumferential alignment length of the balls 165 measured along a central point of the balls is 16˜35% of a circumferential length (L0) of the race portion while the balls are mutually contacted within the race portion 165a.

In other words, a minimum value (L1) of the circumferential alignment length of the balls 165 measured along a central point of the balls 165 is 16% of the circumferential length (L0) of the race portion while the balls 165 are mutually contacted within the race portion 165a, and a maximum value (L2) is 35% of a circumferential length (L0) of the race portion while the balls are mutually contacted within the race portion 165a, where the aligned number of balls is preferably 5˜9 that is determined within a scope of the minimum value (L1) and a maximum value (L2) of the alignment length (L0).

That is, a minimum vale (θ1) of circumferential alignment angle of the balls 165 measured by connecting the central points of the balls 165 while the balls 165 are mutually contacted within the race portion 161a is 57.6° which is 16% of 360°, while a maximum value (θ2) is 126° which is 35% of 360°, where the number of aligned balls 165 is preferably 5˜9 that is determined within a scope of the minimum value (θ1) and a maximum value (θ2) of the alignment angle.

The vibration of the spindle motor was relatively mitigated when the vibration of the spindle motor was measured after the balls 165 are stored with these ratios.

To be more specific, a disk 50 is generally available with an amount of minimum eccentricity of 0.25 g·cm. A vibration of spindle motor generated when the disk 50 having the eccentricity is mounted on the turn table 161 and rotated is measured at 1.26˜1.5 G in case the cross-sectional area of each ball 165 is 16% of that of the race portion 161, at 1.29˜1.37 G in case the cross-sectional area of each ball 165 is 25.5% of that of the race portion 161, and at 1.47˜1.52 G in case the cross-sectional area of each ball 165 is 36% of that of the race portion 161, as shown in FIG. 5. These figures show that the vibration of the spindle motor has been reduced.

The race portion 161a of the turn table 161 may be air-tightly sealed by an upper surface of the rotor yoke 151, in which exemplary embodiment installation of cover 163 may be omitted to thereby obtain an effect of reducing the number of component parts, where the felt 168 is installed on an upper surface of the rotor yoke 151.

The spindle motor according to the present disclosure is advantageous in that the cross-sectional area occupied by the balls relative to that of space in which the balls are stored is optimized to thereby mitigate the generation of vibration caused by the eccentricity of the disk and the turn table.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the disclosure, the drawing and the appended claims. In addition to variations and modifications in the component parts and/or arrangements, alternative uses will also be apparent to those skilled in the art.

What is claimed is:

1. A spindle motor comprising: a turn table simultaneously rotating with a rotation shaft and having a ring-shaped race portion at one side of the turn table, wherein the disk is mounted on the other side of the turn table; a cover coupled to one side of the turn table to seal the race portion; and a plurality of balls stored in the space formed by the race portion and the cover, wherein a circumferential alignment length of the balls measured along a central point of the balls is 16˜35% of a circumferential length of the race portion while the balls are mutually contacted within the race portion.

2. The spindle motor of claim 1, wherein the number of balls is in the range of 5˜9.

3. The spindle motor of claim 1, wherein the cover is installed with a felt supportively contacted by the ball.

4. A spindle motor comprising: a turn table simultaneously rotating with a rotation shaft and having a ring-shaped race portion at one side of the turn table, wherein the disk is mounted on the other side of the turn table; a rotor having a rotor yoke sealing the race portion by being fixed at the rotation shaft; a stator installed about the rotation shaft for rotating the rotation shaft; and a plurality of balls stored in the space formed by the race portion and the cover, wherein a circumferential alignment length of the balls measured along a central point of the balls is 16˜35% of a circumferential length of the race portion while the balls are mutually contacted within the race portion.

5. The spindle motor of claim 4, wherein the number of balls is in the range of 5˜9.

6. The spindle motor of claim 4, wherein the rotor yoke is installed with a felt supportively contacted by the ball.

7. The spindle motor of claim 6, wherein an outer periphery of the rotation shaft on the other surface side of the turn table is vertically movably mounted along the rotation shaft with a center guide member that supports the disk mounted on the turn table, and an outer periphery of the rotation shaft on the center guide member is fixed by a bush for preventing the center guide member from disengaging toward the rotation shaft, and a resilient member that supports the center guide member in the axial and radial directions of the rotation shaft is formed between the turn table and the center guide member.
